(19) United States
(12) Patent Application Publication
(10) Pub. No.: US 2018/0188036 A1
(43) Pub. Date: Jul. 5, 2018

(54) METHOD FOR VALIDATING A DIGITAL MAP FOR A VEHICLE

(71) Applicant: Robert Bosch GmbH, Stuttgart (DE)

(72) Inventors: Carsten Hasberg, Ilsfeld-Auenstein (DE); Christoph Schroeder, Sunnyvale, CA (US); Danny Hiendriana, Ludwigsburg (DE); Oliver Pink, Ditzingen (DE); Philipp Rasp, Wannweil (DE)

(21) Appl. No.: 15/843,555

(22) Filed: Dec. 15, 2017

(30) Foreign Application Priority Data
Jan. 4, 2017 (DE) 102017200072.4

(51) Int. Cl. G01C 21/30

(52) U.S. Cl. CPC G01C 21/30

(57) ABSTRACT

A method for validating a digital map for a vehicle, including radar-based ascertainment of driving-environment data with the aid of an ascertainment device of the vehicle, comparing the ascertained driving-environment data to corresponding data of the digital map, and Verifying a validity of the digital map for the case when the driving-environment data, ascertained based on radar, coincide to a defined extent with the data of the digital map.

### CROSS REFERENCE

The present application claims the benefit under 35 U.S.C. § 119 of German Patent Application No. DE 102017200072.4 filed on Jan. 4, 2017, which is expressly incorporated herein by reference in its entirety.

### BACKGROUND INFORMATION

The present invention relates to a method for validating a digital map for a vehicle. The present invention also relates to an apparatus for validating a digital map for a vehicle. In addition, the present invention relates to a computer-program product.

### FIELD

Numerous advanced driver assistance systems (ADAS) and especially highly automated vehicle systems for AD (automated driving) presume a sufficiently precise vehicle localization or vehicle position finding. In this context, localization systems are often used which employ a global localization map (e.g., callable from a backend server) and a local localization map from a surrounding-field model of the vehicle system.

In the future, there will be a large number of the indicated highly/fully automated driver assistance systems. With these systems, the car drives automatically, that is, the driver is no longer in charge. Localization in an extremely accurate digital map is important for highly/fully automated driving. This means that the vehicle or the driver assistance system must always know exactly where the vehicle is. That presumes a correct, i.e., error-free digital map corresponding to reality. Conventional driving functions which are based on digital maps therefore assume that the data in the digital map are always valid.

U.S. Patent Appl. Pub. No. 2010/0241354 A1 describes a method for verifying digital maps.

German Patent Application No. DE 10 2010 028 090 A1 describes a navigation system and a navigating method for vehicles, where navigation of the vehicle is carried out as a function of stored navigation data that feature confidence levels which indicate a confidence in the correctness of the navigation data.

German Patent Application No. DE 103 37 631 A1 describes a method for controlling vehicle systems, where using predetermined data concerning the route, the predetermined data are compared to actual data of the route which are determined instantaneously with the aid of a suitable sensor and evaluation device. The control of the vehicle systems is at least partially suspended when the predetermined data do not coincide approximately with the actual data.

### SUMMARY

An object of the present invention is to provide an improved system for validating data of a digital map for a vehicle.

The objective may be achieved according to a first aspect of the present invention by an example method for validating a digital map for a vehicle, having the following steps:
Radar-based ascertainment of driving-environment data with the aid of an ascertainment device of the vehicle;
Comparing the ascertained driving-environment data to data of the digital map; and
Verifying a validity of the digital map for the case when the driving-environment data, ascertained based on radar, coincide to a defined extent with the data of the digital map.

The present invention therefore provides a feature-based method for validating data of a digital map for a vehicle. A defined action may be initiated and carried out for the vehicle based on the result of the validation. High sensing quality and high validation quality of the method may be provided advantageously on the basis of the radar-based sensing of features.

According to a second aspect, the objective is achieved by an apparatus for validating a digital map for a vehicle, having:
a radar-based ascertainment device for ascertaining driving-environment data;
a comparator for the algorithmic comparison of the acquired driving-environment data to localization data of the digital map; and
a verification device for verifying a defined coincidence of the driving-environment data acquired based on radar, with the localization data of the digital map.

Advantageous further developments of the method in accordance with the present invention are described herein.

Advantageous further developments of the method in accordance with the present invention provide that the driving-environment data are ascertained based on radar in a close-distance range up to approximately 40 m away from the vehicle and/or in a mid-distance range of approximately 70 to approximately 80 m away from the vehicle. In this way, the objects in the driving environment may be ascertained in a distance range in which map errors can still be detected in time, before the vehicle has reached the incorrect location.

Another advantageous further development of the method provides that in the event the driving-environment data, ascertained based on radar, deviate in defined fashion from the data of the digital map, it is recognized that the digital map is no longer valid. With this defined result, a suitable consequential action, e.g., deactivation of the autonomous driving function, may be initiated.

According to a further advantageous development of the method in accordance with the present invention, a process of determining a trajectory for the vehicle with the aid of a planning map based on the digital map is terminated. In this way, in the case of a highly automated vehicle, use of a planning map for planning trajectories may advantageously be deactivated.

A further advantageous development of the method in accordance with the present invention provides that a safe state is initiated for the vehicle. In this manner, for example, the condition may be realized where the vehicle becomes slower in defined fashion and subsequently stops.

According to another advantageous development of the method, an acoustic and/or visual signal is output in the vehicle. In this way, for example, a message may be output to the driver, by which he is prompted to assume manual control of the vehicle, or by which the driver is informed that the vehicle will soon reduce its speed and stop.

In another advantageous further development of the method, the driving-environment data, ascertained based on radar, are transmitted to a server device. The ascertained data may thus be used to update the data of the digital map. As a result, high quality of the digital map material is advantageously promoted.

The present invention is described in detail hereinafter with further features and advantages based on several figures. The figures are intended above all to clarify the main features of the present invention, and are not necessarily true to scale.

Disclosed method features are derived analogously from corresponding disclosed apparatus features and vice versa. In particular, this means that features, technical advantages and explanations pertaining to the method for validating a digital map are derived analogously from corresponding explanations, features and advantages pertaining to the apparatus for validating a digital map and vice versa.

### BRIEF DESCRIPTION OF THE DRAWINGS

FIG. 1 shows a representation in principle of a vehicle on a roadway.

FIG. 2 shows a representation in principle of a vehicle on a roadway carrying out the proposed method.

FIG. 3 shows a block diagram of a proposed apparatus for validating a digital map for a vehicle.

FIG. 4 shows a schematic functional sequence of one specific embodiment of the method according to the present invention.

### DETAILED DESCRIPTION OF EXAMPLE EMBODIMENTS

In the following, the term automated vehicle is used synonymously in the denotations highly-automated vehicle, semi-automated vehicle, autonomous vehicle and semi-autonomous vehicle.

In particular, the present invention includes sensing objects in the driving environment based on radar and algorithmically comparing the sensed objects to localization data of a digital local map. A suitable action may be initiated for the vehicle based on this comparison/verification.

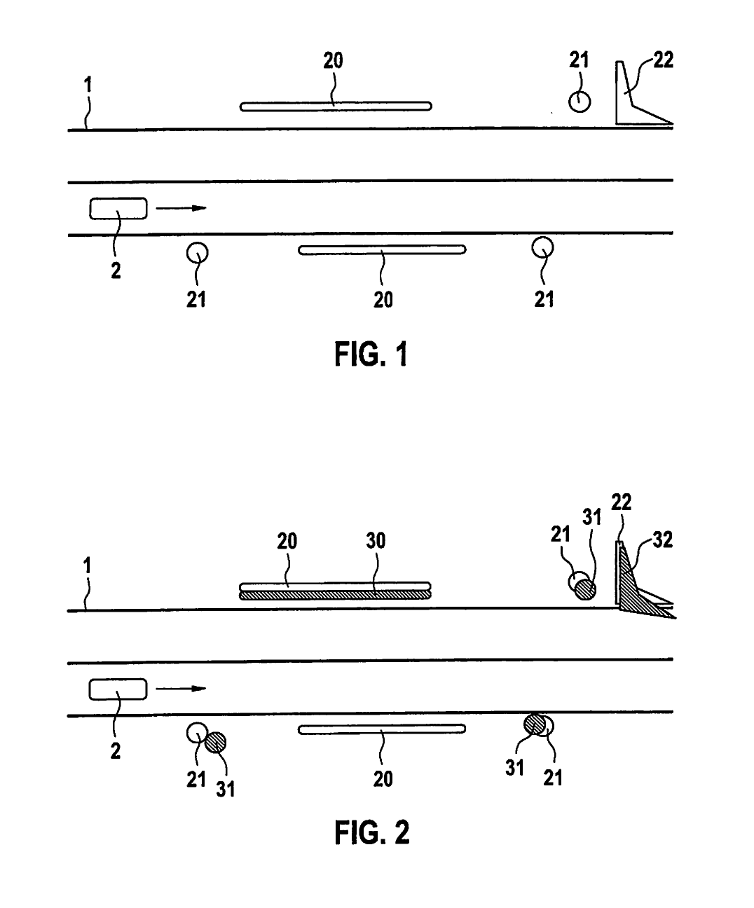

FIG. 1 shows a traffic scenario for which the example method in accordance with the present invention may be used. One sees a vehicle 2 moving on a road 1. Objects 20, 21, 22 are discernible in the driving environment of vehicle 2, which are stored as localization features in a digital map 10. During travel operation of vehicle 2, the data of indicated digital map 10 are compared, preferably continuously, to data of a navigation or planning map (not shown) of vehicle 2. The indicated planning or navigation map is used as basis for determining an instantaneous trajectory for vehicle 2.

For example, localization data of objects 20 (e.g., guardrails), objects 21 (e.g., traffic signs) and objects 22 (e.g., building) are stored in digital map 10. Further objects not shown are also possible for digital map 10.

In FIG. 2, it is shown that during the travel of vehicle 2, with the aid of a radar-based ascertainment device 110 of vehicle 2, data of objects 30, 31 and 32 in the driving environment of vehicle 2 are ascertained based on radar in a range of approximately 40 m away from vehicle 2 (“close range”) or in a distance range of approximately 70 m to approximately 80 m away from vehicle 2 (“mid-distance range”). The radar data ascertained in so doing (e.g., radar spectra, radar detections, time signals of one or more radar sensors, etc.) are compared algorithmically to the corresponding data of objects 20, 21, 22 of digital map 10.

In this way, errors in digital map 10 may be recognized advantageously at a point in time at which vehicle 2 has not yet reached/passed the location corresponding to the incorrect data in digital map 10. For example, map errors caused by changes in the road infrastructure are able to be detected. As a result, suitable actions may be initiated in good time on the part of vehicle 2.

It is discernible that at most locations, the measured features coincide with the features stored in digital map 10, that is, an object 20 in map 10 coincides with object 30 measured or determined using radar technology, objects 21 in map 10 coincide with objects 31 measured or determined using radar technology, and an object 22 in map 10 coincides with object 32 measured or determined using radar technology.

It can be seen that in the lower section of FIG. 2, no object 30 corresponding to object 20 is ascertained by radar-based ascertainment device 110 of vehicle 2, which is interpreted as a strong indication that the real circumstances have changed in comparison to the data in digital map 10 (e.g., due to a construction site). As a result of this information, a defined procedure is initiated and carried out by vehicle 2.

Conventional algorithms may be used for performing the indicated algorithmic comparison of the data records of the data in digital map 10 to the data records of the driving-environment data ascertained based on radar.

For example, a suitable consequential action may be that, in response to the recognized deviation of the indicated data, a visual and/or acoustic signal is output in vehicle 2, by which the driver of vehicle 2 is prompted to take over the manual control of vehicle 2 as of now, or that in a moment, vehicle 2 will begin a defined braking and stopping procedure. Moreover, a driver assistance system of vehicle 2 may be triggered to carry out the indicated functions.

It is also possible that the indicated ascertained driving-environment data are transmitted to a (e.g., central, cloud-based) server device (not shown), so that digital map 10 may be updated.

The indicated radar-based data may also be ascertained by a manually controlled vehicle 2, the differences determined between ascertained objects 30, 31, 32 and data 20, 21, 22 of digital map 10 being transmitted to the server device and used for updating the map material of digital map 10. Transmitting and receiving units are provided on the vehicle side for transmitting the data.

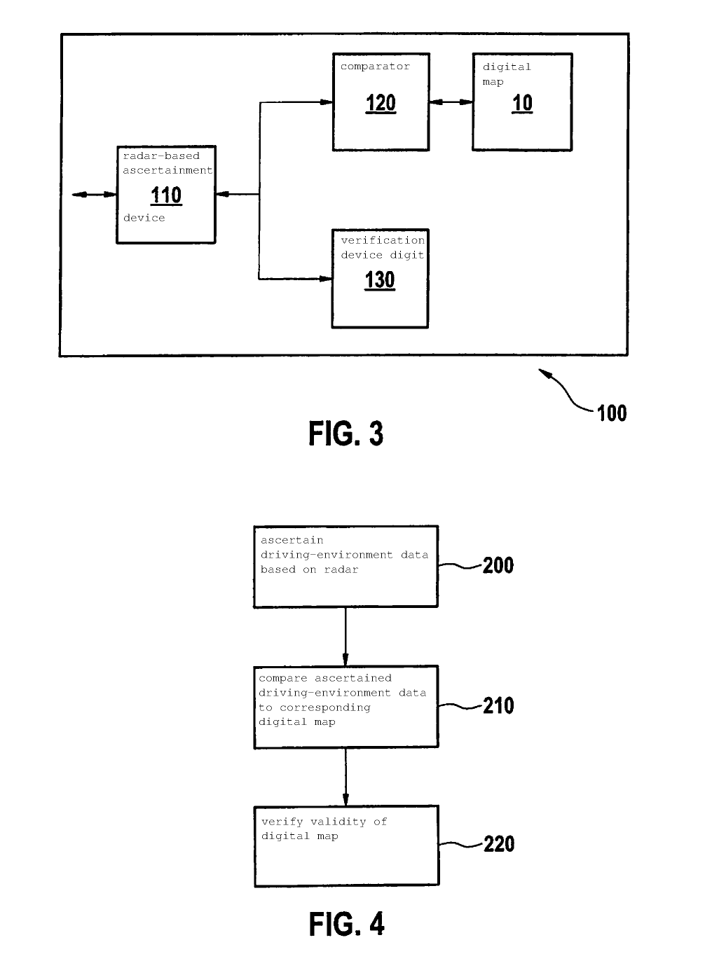

FIG. 3 shows a highly simplified block diagram of an apparatus 100 for validating a digital map 10. Radar-based ascertainment device 110 is discernible, which is connected functionally to a comparator 120. Objects in the driving environment are ascertained by ascertainment device 110, ascertained data of the driving-environment objects being compared by comparator 120 to data of digital map 10. With the aid of a verification-device digit 130, it is verified whether the data of the sensed driving-environment objects coincide to a defined extent with the data of digital map 10. If this is not the case, one of the actions indicated above is initiated and carried out, or the data of digital map 10 are falsified. Advantageously, the indicated method may be realized as software having program-code means, which, for example, is executed on a computing or control device of vehicle 2. A simple update of the method is thus advantageously possible.

FIG. 4 shows a functional sequence in principle of one specific embodiment of the proposed method.

In a step 200, driving-environment data are ascertained based on radar with the aid of an ascertainment device 110 of vehicle 2.

In a step 210, the ascertained driving-environment data are compared to corresponding data of digital map 10.

In a step 220, validity of digital map 10 is verified for the case when the driving-environment data, ascertained based on radar, coincide to a defined extent with the data of digital map 10.

Advantageously, as an alternative, the sensed driving-environment objects may also be sensed with the aid of a different ascertainment device, e.g., with the aid of an optical camera, and the driving-environment data thus ascertained may be compared to the localization data of the digital map. In this case, different algorithms must be carried out for determining and evaluating the objects, compared to the radar-based ascertainment described.

One skilled in the art will alter the features of the present invention and/or combine them with each other in suitable manner, without departing from the essence of the present invention.

What is claimed is:

1. A method for validating a digital map for a vehicle, comprising:
radar-based ascertaining driving-environment data with the aid of an ascertainment device of the vehicle;
comparing the ascertained driving-environment data to corresponding data of the digital map; and
verifying a validity of the digital map for the case when the driving-environment data, ascertained based on radar, coincide to a defined extent with the data of the digital map.

2. The method as recited in claim 1, wherein the driving-environment data are ascertained based on radar at least one of: (i) in a close-distance range up to approximately 40 m away from the vehicle, and (ii) in a mid-distance range of approximately 70 to approximately 80 m away from the vehicle.

3. The method as recited in claim 1, wherein in the event the driving-environment data, ascertained based on radar, deviate in defined fashion from the data of the digital map, recognizing that the digital map is no longer valid.

4. The method as recited in claim 3, wherein a process of determining a trajectory for the vehicle with the aid of a planning map based on the digital map is terminated.

5. The method as recited in claim 3, wherein a safe state is initiated for the vehicle.

6. The method as recited in claim 3, wherein at least one of an acoustic signal and a visual signal is output in the vehicle.

7. The method as recited in claim 3, wherein the driving-environment data ascertained based on radar are transmitted to a server device.

8. The method as recited in claim 1, wherein the method is used of at least one of an automated and manually controlled vehicle.

9. An apparatus for validating a digital map for a vehicle, comprising:
a radar-based ascertainment device for ascertaining driving-environment data;
a comparator for an algorithmic comparison of the acquired driving-environment data to localization data of the digital map; and
a verification device for verifying a defined coincidence of the driving-environment data acquired based on radar, with the localization data of the digital map.

10. A non-transitory computer-readable data carrier on which is stored a computer-program product having program-code for validating a digital map for a vehicle, the program code, when executed by a computing device, causing the computing device to perform:
radar-based ascertaining driving-environment data with the aid of an ascertainment device of the vehicle;
comparing the ascertained driving-environment data to corresponding data of the digital map; and
verifying a validity of the digital map for the case when the driving-environment data, ascertained based on radar, coincide to a defined extent with the data of the digital map.
